(19) United States
(12) Patent Application Publication
(10) Pub. No.: US 2002/0104209 A1
(43) Pub. Date: Aug. 8, 2002

(54) Method for producing a hollow body made of aluminium or an aluminum alloy

(76) Inventor: Fritz Rosch, Schwabach (DE)

Correspondence Address: Cooper & Dunham LLP, 1185 Avenue of the Americas, New York, NY, 10036, US

(21) Appl. No.: 10/077,424

(22) Filed: Feb. 14, 2002

Related U.S. Application Data
(63) Continuation-in-part of application No. PCT/EP00/08056, filed on Aug. 17, 2000.

(30) Foreign Application Priority Data
Aug. 17, 1999 (DE) DE 199 38 846.6

(51) Int. Cl. B21J 5/04; B23P 17/00

(52) U.S. Cl. 29/421.1; 29/897.2; 72/54

(57) ABSTRACT

A method for producing a hollow body made of aluminum or an aluminum alloy comprises the following steps:

furnishing a preform permitting charging with a pressure medium and which is closed off with the exception of an inlet conduit, and

forming said hollow body by applying the pressure medium to the preform via the inlet conduit,

varying the temperature of the pressure medium during forming of the hollow body.

### FIELD OF THE INVENTION

The invention relates to a method for producing a hollow body made of aluminum or an aluminum alloy as set forth in the preamble of claim 1.

Fabricating hollow bodies of the cited materials cannot be usually implemented, due to they being less suitable for forming and welding, by the methods as usual for hollow bodies, for example, tanks made of steel. For one thing, deep drawing and stretch forming steel is less of a problem than with aluminum. For another, it is less suitable for welding than steel and thus fails to permit fully circumferentially welding two half-shells each formed separately from the other.

### PRIOR ART

Known from DE 197 53 258 is a method for producing hollow bodies by means of internal high-pressure forming. This method can be put to use, more particularly, for forming tubular or blanked stock workpieces. A pressure medium, existing in any aggregate condition and in any transitional phase between its aggregate conditions, is introduced into the cavity of the workpiece to be formed. The aggregate condition of the pressure medium is either maintained or varied by the effect of electricity, heat, cold or magnetism before the pressure medium is pressurized to form the workpiece.

More particularly, the method for producing hollow bodies made of aluminum or an aluminum alloy as set forth in the preamble of claim 1 of DE 195 31 035 A1 of the assignee has a proven record of success. In accordance therewith one or more substantially flat sheet metal blanks of aluminum or aluminum alloy are furnished and folded and/or superimposed so that their edge portions can be joined to each other such that a closed structure materializes. This closed structure comprises at least one inlet conduit into which a pressure medium is subsequently introduced so that the hollow body is formed to some extent by the application of an internal high pressure. This popular procedure has, for one thing, the advantage that the sheet metal blanks can be joined, more particularly, soldered to each other in a substantially flat condition so that relatively small soldering ovens can be used in enabling the investment costs to be minimized. For another, forming the aluminum or aluminum alloy blanks can be implemented by means of a heated pressure medium resulting in the blanks having a temperature well suited for forming them.

There is room for improving this known method due to the fact that the material not only gains in permitting forming by the effect of the hot pressure medium, it also loses strength, resulting in deep drawing only being possible with the latent risk of cracking since the material needs to be formed to such an extent that instead of continuous forming it tends to crack in the presence of a relatively hot pressure medium.

### SUMMARY OF THE INVENTION

The invention is thus based on the objective of further improving the generic method such that all forming procedures as needed for aluminum or aluminum alloy blanks are now possible.

In the method in accordance with the invention the temperature of the pressure medium is varied whilst the pressure medium is pressurized in thus forming the workpiece. This enables the temperature of the applied pressure medium and thus the temperature of the sheet metal blanks to be formed to be adapted during forming such that the necessary steps in the method can now be implemented without the risk of the blanks cracking. This takes more particularly into account that for stretch forming/deep drawing, a hot pressure medium is needed but that at the same time the hot pressure medium may result in the material losing its strength and possibly cracking on deep drawing. On the other hand, higher temperatures are needed for implementing stretch forming when the material is thus not only formed but, in addition, stretched during forming such that its surface is increased in reducing the thickness of the blank.

When forming the blanks is controlled such that deep drawing can first be implemented up to a certain extent before stretch forming is done, or vice-versa, the method in accordance with the invention is then able to create the marginal conditions permitting implementation of both steps in the method under suitable conditions and without the risk of the blanks cracking in thus making it possible to configure complex tank shapes. This is done, as aforementioned, by varying the temperature of the pressure medium in forming the blanks such that lower temperatures exist in implementing deep drawing than in implementing stretch forming. More particularly, the pressure medium is pressurized whilst its temperature is varied.

The method is applicable to any preforms capable of being “inflated” or pressurized with a pressure medium. Accordingly, a first step in the method involves providing a structure or configuration suitable for being pressurized with a pressure medium and which, with the exception of at least one inlet conduit, is closed off. This closed structure may be achieved by the preform alone or by its cooperation with a die in which the preform is placed. Subsequently the hollow body is formed by introducing a pressure medium into the preform via the inlet conduit. The preform may be, for example, a tube as produced by any suitable ways and means. For example, the tube could be fabricated from a strip-formed sheet metal blank formed into a tube and comprising a longitudinal weld. As an alternative a seam configured on the tube could be folded or configured by any other suitable ways and means. The tube may however also be fabricated without a seam by a suitable method of production such as e.g. extruding. Furthermore conceivable is making use of a tube having a cross-section which changes in the longitudinal direction of the tube or, for example, is configured flared or conical at least sectionwise. Even relatively complex parts such as e.g. axle beams, pillars or other parts of a body, more particularly a vehicle body, can now be fabricated by means of the method in accordance with the invention from one such mainly tubular preform.

Furthermore, the invention relates primarily to the step in the method involving introducing a pressure medium into the hollow body, resulting in the hollow body being configured more particularly in the tank. Regarding all other steps in the method, reference is made to DE 195 31 035 A1 as well as, supplementary thereto, to DE 198 51 259 of the assignee, the disclosure of which is made subject matter of the present application in this case by the reference. In addition to the methods proposed in the cited documents for joining the sheet metal blanks along their edges it is to be noted that this is possible not only by soldering or welding but also by bonding. In conclusion, it is not a mandatory requirement for joining the edges that they overlap.

Instead, “butt” jointing the edges of the sheet metal blanks is possible. These butt joints are subsequently soldered or welded to each other. It is furthermore conceivable to superimpose and/or form one or more sheet metal blanks so that a body having a hollow interior, i.e. a tubular body materializes. Such a body could be fabricated from a sole sheet metal blank by suitable forming thereof and welding or folding the edge portions in configuring such a tubular body.

Varying the temperature of the pressure medium during forming of the sheet metal blank(s) may be done by any suitable ways and means. In certain applications it is good practice to vary the temperature continuously so that the temperature of the sheet metal blanks correspondingly changes continuously and that temperature conditions exist at each point in time which create the best marginal conditions for the forming action being implemented at the time. More particularly, the temperature of the additionally applied medium may be varied. Since the volume of the hollow body becomes continuously larger, the temperature of the pressure medium contained in the hollow body in each case likewise varies.

As an alternative, good results were established in trial and error by varying the temperature of the pressure medium in discrete steps. In other words, in this case, the pressure medium is applied over a certain period of time at a specific temperature and subsequently the pressure medium is abruptly applied at another temperature so that the temperature of the mix present in the continuously configured cavity gradually changes. Varying the temperature of the pressure medium in this way can be controlled such that as of a certain point in time, as of which, for example, stretch forming is implemented, the minimum temperature required for this purpose is available, whilst the temperature up to this point in time, during which, for example, deep drawing occurs, is maintained low enough so that the aluminum or aluminum alloy blanks retain the necessary strength.

Varying the temperature of the pressure medium during forming of the blanks may, however, also be done by replacing a pressure medium applied in a first step subsequently so-to-speak in the second step by a pressure medium at another temperature. In other words, once a certain forming under the temperature conditions suitable therefor has been implemented, the pressure medium applied for this purpose is drained by it being expelled by a subsequent pressure medium applied at another temperature. Thus, by suitably controlling the inlet and outlet valves the pressure medium of the first step is first replaced and subsequently the further pressure medium of the second step, i.e. at the other temperature, is applied to continue forming under other such temperature conditions.

In general, applying the pressure medium at a suitable temperature thus controls the forming properties of the material as specified. In this arrangement, forming the folded and/or superimposed sheet metal blanks joined to each other at their edges can be controlled particularly favorably by them being inserted in a lockable die prior to applying a pressure medium. This die can be configured to advantage such that deep drawing and stretch forming take place defined separately from each other so that, for example, up to a certain volume of the hollow body to be formed a pressure medium is applied at a suitable temperature and subsequently, when the die is configured such that further forming is done by stretch forming, correspondingly hotter pressure medium is applied to create the marginal conditions suitable therefor.

In conclusion, a hydraulic medium, more particularly hydraulic fluid, is preferred as the pressure medium, although using hot gases is just as possible.

For joining the edge portions of the sheet metal blank(s) to each other it is preferred to butt joint these. In other words, no overlap of the edge portions is needed in this portion. Instead, the two edges can be butted together and joined to each other by “butt welding” or soldering. This procedure has a proven record of success especially for load-bearing parts, such as for vehicle bodies, for example.

### EXAMPLE EMBODIMENT

As an example embodiment of the invention the following coarse of action is detailed. Assuming that the end product to be fabricated is a tank of aluminum or aluminum alloy sheet metal blanks having a volume of 80 liters, this can be formed by the following two steps: in the first step the temperature, assuming folded and/or superimposed sheet metal blanks joined to each other by their edges is formed by applying fluid at a temperature of approx. 120° C. to a volume of 40 liters, in being inflated, so-to-speak. Fluid at this temperature does not degrade the strength of the blanks in thus permitting deep drawing with no problem.

Assuming stretch forming is to be implemented in the second step, requiring a higher temperature of the hydraulic fluid, for example 120° C. to 200° C., this is achievable by applying to the 40 liters of fluid already in the hollow body at a temperature of 120° C. a further 40 liters of hydraulic fluid at a temperature of 280° C. This means that the temperature of the existing fluid (120° C.) is continuously increased to a temperature of approx. 200° C., the temperature range 120° to 200° C. being suitable for implementing stretch forming. In other words, by providing a blend of hydraulic fluid at the suitable temperature stretch forming can be suitably implemented, whereby at the same time the deep drawing implemented in the first step can be implemented by using cooler fluid under likewise suitable conditions.

It will readily be appreciated that the vice-versa sequence is just as conceivable by stretch forming being done in the first step by applying relatively hot fluid, for example at 200° C., in subsequently attaining—by mixing the hot fluid with the significantly cooler fluid —a temperature of the pressure medium at which deep drawing of the material is possible. This is possible because the forming properties of aluminum or aluminum alloy suitable for this are now maintained without risking cracking. As aforementioned, it is just as possible to continuously vary the temperature or to displace an already applied pressure medium having a specific temperature by a pressure medium at another temperature and to implement further forming by means of the pressure medium applied later.

A further example of a hollow body which can be fabricated by means of the method in accordance with the invention is a hollow beam, for example of aluminum as used in body building, especially in automobiles.

1. A method for producing a hollow body made of aluminum or an aluminum alloy comprising the following steps.
furnishing a preform permitting charging with a pressure medium and which is closed off with the exception of an inlet conduit, and
forming said hollow body by applying said pressure medium to said preform via said inlet conduit,
varying the temperature of said pressure medium during forming of said hollow body.

2. The method as set forth in claim 1, wherein said preform is a tube.

3. The method as set forth in claim 2 wherein said tube is fabricated seamless by extrusion.

4. The method as set forth in claim 2 wherein said tube comprises a seam.

5. The method as set forth in claim 4 wherein said seam is welded.

6. The method as set forth in claim 4 wherein said seam is folded.

7. The method as set forth in claim 1 or 2 wherein said hollow body is an axle beam, a pillar or some other part of a vehicle body.

8. A method for producing a hollow body made of aluminum or an aluminum alloy comprising the following steps.
furnishing at least one flat sheet metal blank,
joining the edge portions of said sheet metal blank(s) to each other such that with the exception of at least one inlet conduit a closed configuration materializes, and
forming said hollow body by applying a pressure medium via said inlet conduit,
characterized in that the temperature of said pressure medium is varied during forming of said hollow body.

9. The method as set forth in claim 1 or 8 wherein forming is initially done by deep drawing and subsequently, at a higher temperature of said pressure medium, by stretch forming.

10. The method as set forth in claim 1 or 8, characterized in that the temperature of said pressure medium is continuously varied.

11. The method as set forth in claim 1 or 8, characterized in that the temperature of said pressure medium is varied in discrete steps.

12. The method as set forth in claim 1 or 8, characterized in that a pressure medium applied in a first step is replaced by a pressure medium at another temperature.

13. The method as set forth in claim 1 or 8, characterized in that said folded and/or superimposed sheet metal blanks are inserted in a lockable die prior to application of said pressure medium.

14. The method as set forth in claim 1 or 8, characterized in that a hydraulic medium, more particularly hydraulic fluid, is used as said pressure medium.

15. The method as set forth in claim 1 or 8, characterized in that said edge portions of said sheet metal blank(s) are butt jointed.
